(19) United States
(12) Patent Application Publication
(10) Pub. No.: US 2004/0165315 A1
(43) Pub. Date: Aug. 26, 2004

(54) Base seat for a sled motor

(75) Inventor: Hung-Jui Lin, Taipei (TW)

Correspondence Address: BRUCE H. TROXELL, SUITE 1404, 5205 LEESBURG PIKE, FALLS CHURCH, VA, 22041, US

(73) Assignee: EPO Science & Technology Inc.

(21) Appl. No.: 10/354,031

(22) Filed: Jan. 30, 2003

(51) Int. Cl. G11B 5/60; G11B 17/32; G11B 21/20

(52) U.S. Cl. 360/220

(57) ABSTRACT

A base seat for a sled motor, which can lower the height of the sled motor beyond a flat body of the traverse so as to reduce the gross thickness of a CD-ROM driver and to be favorable for design work, has a downward recessing joining surface for engaging with the sled motor. The joining surface at two lateral sides thereof extends a connecting plate to connect with the flat body of the traverse. The flat body has a downward bent reinforced rib close to the outer side of the joining surface. The joining surface at a lateral side thereof extends a projection plate to be associated with one of the transmission gears.

### BACKGROUND OF THE INVENTION

1. Field of the Invention:

The present invention relates to a CD-ROM driver, and, particularly, to an improvement on a base seat of a metal traverse, which engages with a sled motor in a CD-ROM driver.

2. Description of Related Art:

A conventional CD-ROM driver usually has an optical pickup to read out the data in the CD-ROM. Referring to FIG. 1, a traverse 10 of the CD-ROM driver is associated with a turntable 11 to rotate the CO-ROM. The optical pickup 12 has a pickup head 13 and both lateral sides of the pickup head 13 fit with a bar 14, 15 respectively. The sled motor 16 engages with a base seat 101 of the traverse 10 to actuate a transmission gear train, which is belonged to prior art and not shown in the Figure. The pickup head 13 is driven by the gear train to move reciprocally along the two bars 14, 15 such that the optical pickup 12 can access the data on the CD-ROM. The preceding base seat 101 is disposed at the same plane as the traverse 10 and the sled motor 16 is fixedly attached to the upper side of the base seat 101. However, the sled motor 16 at the top thereof is much higher than the flat body 100 of the traverse 10 so that the outer case of the CD-ROM driver has to be designed the height thereof being increased so as to be capable of receiving the sled motor 16.

### SUMMARY OF THE INVENTION

The crux of the present invention is to lower the position of the sled motor during being engaged to the traverse so as to reduce the height of the sled motor beyond the flat body of the traverse under a trend of the CD-ROM driver being designed to meet criterion of lightness, thinness, shortness and littleness.

Therefore, a primary object of the present invention is to provide a base seat for a sled motor so that the sled motor at the top thereof has a height beyond the flat body of the traverse being reduced and the CD-ROM driver at the gross height thereof can be lowered for being favorable for the designer during deciding the size of the CD-ROM driver.

### BRIEF DESCRIPTION OF THE DRAWINGS

The present invention can be more fully understood by reference to the following description and accompanying drawing, in which:

FIG. 1 is a perspective view of a conventional traverse;

FIG. 2 is a perspective view of a traverse according to the present invention before being assemble to the sled motor; and

FIG. 3 is a perspective view of the traverse shown in FIG. 2 after being assembled.

### DETAILED DESCRIPTION OF THE PREFERRED EMBODIMENT

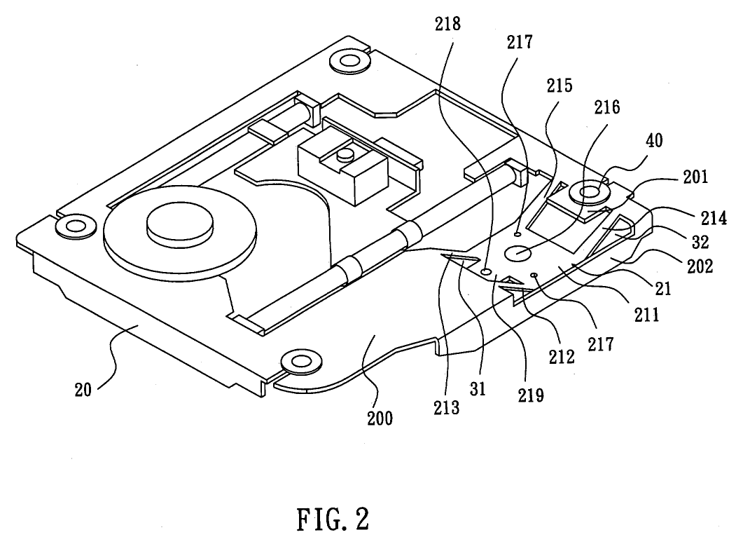

Referring to FIG. 2, a traverse 20 in a CD-ROM driver according to the present invention is different from the conventional traverse 10 in that a base seat 21 for a sled motor 21 has a downward recessing joining surface 211. The joining surface 211 at two lateral sides thereof extends four connecting plates 212, 213, 214, 215 to connect with a flat body 200 of the traverse 20. A hollow part 31, 32 is disposed between the connecting plates 212, 213 and between the connecting plates 214, 215. The joining surface 211 has a shaft hole 216 for being passed through by a rotational shaft of the sled motor and has two holes 217 for being passed through by a screw respectively so as to fasten an outer casing of the sled motor. The joining surface 211 at the hollow part 31 extends a projection plate 219 with a hole 218 and the hole 218 is used for being associated with a gear of a transmission gear train. The flat body 200 at the hollow part 32 extends a projection plate 201 with a hole therein and the hole engages with a shock absorption pad 40. The flat body 200 has an outer side, which is close to the base seat 21, with a bent downward reinforced rib 202 so as to obtain a structurally stronger outer side of the flat body 200 such that the base seat 21 is unable to become bent and deformed and it is capable of keeping the sled motor at a constant elevation.

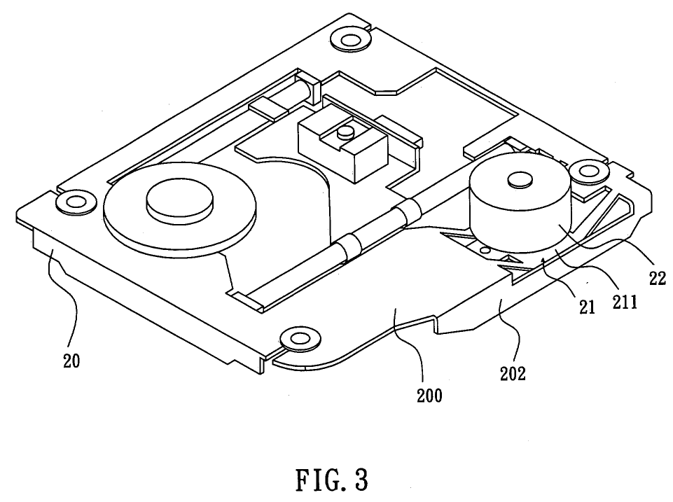

Referring to FIG. 3, the sled motor 22 is disposed on and jointed to the joining surface 211. Because the joining surface 211 is provided under the flat body 200 of the traverse 20, the sled motor 22 at the top thereof can be lowered down so as to shorten the thickness of the traverse 20. Hence, it is possible for the CD-ROM driver to be provided with a thinner height.

Referring to FIG. 2, the four connecting plates 212, 213, 214 and 215 are so designed that they can be stretched a length to let the joining surface 211 be recessed downward a distance easily. Further, the projection plate 219 is provided to allow a gear, which meshes with the rotational shaft of the sled motor, be kept at the same elevation as the rotational shaft. Moreover, the projection plate 201 is provided to allow the shock absorption pad 40 be kept at the same elevation as other shock absorption pads so that it is not necessary to increase lengths of the joining surface 211 and the flat body 200.

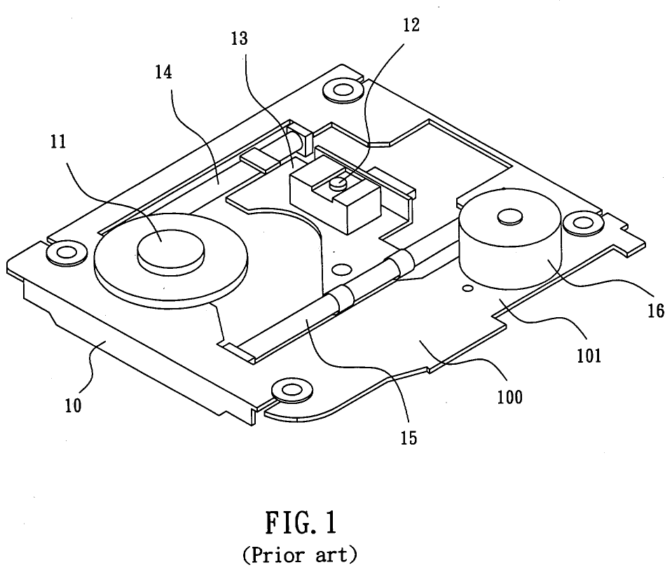

Under a condition of the flat body 200 maintaining the same length as the flat body 100 shown in FIG. 1 without an extra length, the joining surface of the base seat 21 being provided with a small downward recess is helpful for the CD-ROM driver being designed to meet an approach with regard to lightness, thinness, shortness and littleness.

While the invention has been described with reference to a preferred embodiment thereof, it is to be understood that modifications or variations may be easily made without departing from the spirit of this invention, which is defined by the appended claims.

What is claimed is:

1. A base seat for a sled motor, comprising:
a traverse, having a flat body and the flat body being provided with a downward recessing joining surface for engaging with the sled motor.

2. The base seat for a sled motor according to claim 1, wherein the joining surface at a lateral side thereof extends at least a connecting plate to connect with the flat body.

3. The base seat for a sled motor according to claim 1, wherein the joining surface at a lateral side thereof extends two connecting plates to connect with the flat body with a hollow part between the two connecting plates and the joining surface extends a projection plate at the hollow part to be associated with a gear in a transmission gear train of the sled motor.

4. The base seat for a sled motor according to claim 1, wherein the flat body has a downward bent reinforced rib close to an outer side of the joining surface.

5. The base seat for a sled motor according to claim 2, wherein the joining surface at another lateral side thereof at least extends a connecting plate to connect with the flat body.

6. The base seat for a sled motor according to claim 2, wherein the flat body has a downward bent reinforced rib close to an outer side of the joining surface.

7. The base seat for a sled motor according to claim 3, wherein the joining surface at another side thereof at least extends at least two connecting plates connecting the flat body of the traverse with another hollow part between the two connecting plates and the flat body extends a projection plate to be associated with a shock absorption pad.

8. The base seat for a sled motor according to claim 3, wherein the flat body has a downward bent reinforced rib close to an outer side of the joining surface.

9. The base seat for a sled motor according to claim 5, wherein the flat body has a downward bent reinforced rib close to an outer side of the joining surface.

10. The base seat for a sled motor according to claim 7, wherein the flat body has a downward bent reinforced rib close to an outer side of the joining surface.
